(19) United States
(12) Patent Application Publication
(10) Pub. No.: US 2021/0181438 A1
(43) Pub. Date: Jun. 17, 2021

(54) OPTICAL FIBER CONNECTION COMPONENT

(71) Applicant: SUMITOMO ELECTRIC INDUSTRIES, LTD., Osaka (JP)

(72) Inventor: Yasuomi KANEUCHI, Osaka-shi (JP)

(73) Assignee: SUMITOMO ELECTRIC INDUSTRIES, LTD., Osaka (JP)

(21) Appl. No.: 17/184,113

(22) Filed: Feb. 24, 2021

Related U.S. Application Data
(63) Continuation of application No. PCT/JP2019/033052, filed on Aug. 23, 2019.

(30) Foreign Application Priority Data
Aug. 27, 2018 (JP) 2018-158779

(51) Int. Cl. G02B 6/42

(52) U.S. Cl. CPC G02B 6/4239; G02B 6/4243

(57) ABSTRACT

An optical fiber connection component includes: an optical fiber; a first fixing member to which one end portion of the optical fiber is fixed; and a second fixing member that includes either one or both of an outer peripheral wall and an inner peripheral wall having a curvature along which the optical fiber is aligned and being adhered to the optical fiber with the adhesive and a positioning portion for positioning the first fixing member at one end of the second fixing member.

### CROSS-REFERENCE TO RELATED APPLICATION(S)

This application is a continuation of PCT application No. PCT/JP19/033052, which was filed on Aug. 23, 2019 based on Japanese Patent Application No. 2018-158779 filed on Aug. 27, 2018, the contents of which are incorporated herein by reference.

### TECHNICAL FIELD

The present disclosure relates to an optical fiber connection component.

### BACKGROUND ART

As an optical module is miniaturized, when one end portion of an optical fiber is vertically and oppositely spliced to a circuit board on which an optical element such as a light emitting element, a light receiving element, and an optical circuit is mounted, it is required to reduce a height of an optical fiber connection component so as to keep a height of the optical fiber from the circuit board low. In order to reduce the height of the optical fiber connection component, it is necessary to bend a vicinity of a tip of the optical fiber with a small radius. Therefore, Patent Literature 1 discloses an optical connector in which the optical fiber is curved by forming a curved hole in a connector body and by inserting and fixing the optical fiber in the hole.

### CITATION LIST

### Patent Literature

Patent Literature 1: JP-A-2007-156006

### SUMMARY OF INVENTION

An optical fiber connection component according to one aspect of the present disclosure includes: an optical fiber; a first fixing member to which one end portion of the optical fiber is fixed; and a second fixing member that includes either one or both of an outer peripheral wall and an inner peripheral wall having a curvature along which the optical fiber is aligned and being adhered to the optical fiber 10 with the adhesive and a positioning portion for positioning the first fixing member at one end of the second fixing member.

### BRIEF DESCRIPTION OF DRAWINGS

FIG. 1A is a front view illustrating an example of an optical fiber provided in an optical fiber connection component of the present disclosure.

FIG. 1B is a side view illustrating the optical fiber of FIG. 1A.

FIG. 2A is a front view illustrating an example of a first fixing member provided in the optical fiber connection component of the present disclosure in a state where the optical fiber is fixed thereto.

FIG. 2B is a plan view illustrating the first fixing member of FIG. 2A in the state where the optical fiber is fixed thereto.

FIG. 2C is a front view illustrating another example of the first fixing member provided in the optical fiber connection component of the present disclosure in a state where the optical fiber is fixed thereto.

FIG. 2D is a plan view illustrating the first fixing member of FIG. 2C in the state where the optical fiber is fixed thereto.

FIG. 3A is a perspective view illustrating an example of a second fixing member provided in the optical fiber connection component of the present disclosure.

FIG. 3B is a side view of the second fixing member illustrated in FIG. 3A.

FIG. 3C is a diagram illustrating an example in which the first fixing member is mounted on the second fixing member illustrated in FIG. 3A.

FIG. 4A is a perspective view illustrating another example of the second fixing member provided in the optical fiber connection component of the present disclosure.

FIG. 4B is a side view of the second fixing member illustrated in FIG. 4A.

FIG. 4C is a diagram illustrating an example in which the first fixing member is mounted on the second fixing member illustrated in FIG. 4A.

### DESCRIPTION OF EMBODIMENTS

### Technical Problem

The optical connector disclosed in Patent Literature 1 has a possibility that the optical fiber may be broken when the optical fiber whose coating is stripped is inserted into the curved hole. The present disclosure provides an easy-to-assemble optical fiber connection component for bending the optical fiber without requiring a connector member including the curved hole.

### DESCRIPTION OF EMBODIMENTS OF THE PRESENT DISCLOSURE

First, embodiments of the present disclosure will be listed and described.

(1) An optical fiber connection component according to one aspect of the present disclosure includes: an optical fiber; a first fixing member to which one end portion of the optical fiber is fixed; and a second fixing member that includes either one or both of an outer peripheral wall and an inner peripheral wall having a curvature along which the optical fiber is aligned and being adhered to the optical fiber with the adhesive and a positioning portion for positioning the first fixing member at one end of the second fixing member.

According to the above-described configuration, the optical fiber adheres along either one or both of the outer peripheral wall and the inner peripheral wall of the second fixing member, thereby making it possible to obtain an easy-to-assemble optical fiber connection component for bending the optical fiber without requiring a connector member including a curved hole.

(2) It is desirable that the second fixing member includes a side wall from which either one or both of the outer peripheral wall and the inner peripheral wall vertically protrudes and having an open surface on a side opposite to the side wall with a wall surface of either one or both of the outer peripheral wall and the inner peripheral wall interposed therebetween. According to the above-described configuration, it becomes easy to mount the first fixing member on which the optical fiber is mounted on the second fixing member, thereby reducing a possibility of damaging the optical fiber when the optical fiber is bent.

(3) It is desirable that the positioning portion at the one end portion includes: a positioning surface parallel to the optical fiber a positioning surface perpendicular thereto; and a tapered surface connected to the positioning surface perpendicular thereto. According to the above-described configuration, when the first fixing member on which the optical fiber is mounted is mounted on the second fixing member, there is no possibility that a part of the optical fiber coming out of the first fixing member is damaged by contacting the positioning portion of the second fixing member.

(4) The first fixing member may include a hole through which the optical fiber penetrates, and (5) the first fixing member may include two plate-shaped members that sandwich the one end portion of the optical fiber. According to the above-described configuration, the first fixing member can be selected from a plurality of configurations.

### Details of Embodiments of the Present Disclosure

Hereinafter, a desirable embodiment according to an optical fiber connection component of the present disclosure will be described with reference to the drawings. In the following description, since a configuration denoted by the same reference sign even in a different drawing is regarded as the same configuration, the description thereof may be omitted. The present invention is not limited to examples in these embodiments, and includes all the modifications within the scope of matters described in the scope of the claims and within the scope equivalent thereto. As long as a combination of a plurality of embodiments can be performed, the present invention includes a combination of any embodiments.

### First Embodiment

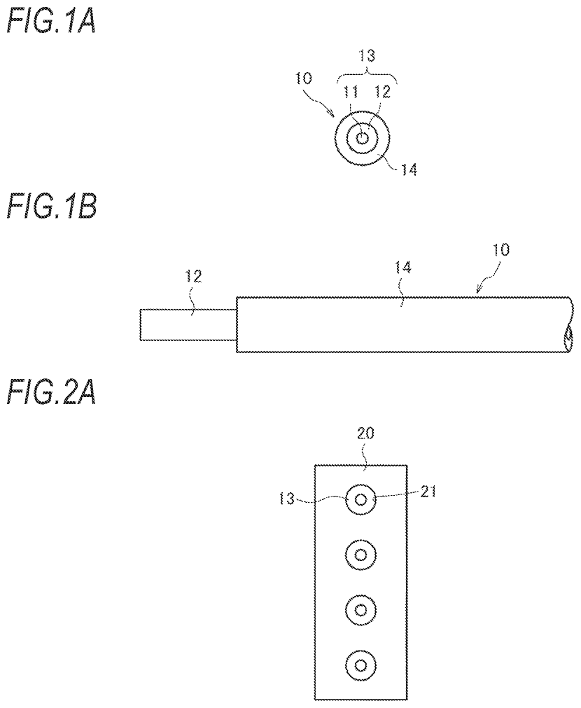

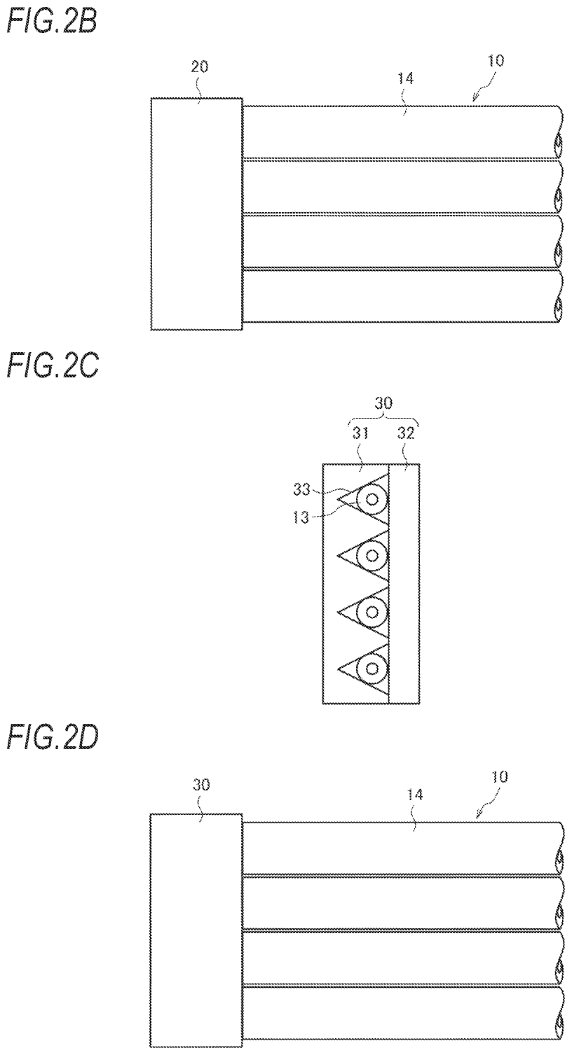

FIGS. 1A and 1B are a front view and a side view illustrating an example of an optical fiber provided in an optical fiber connection component of the present disclosure, respectively. FIGS. 2A and 2B are a front view and a side view illustrating an example of a first fixing member provided in the optical fiber connection component of the present disclosure in a state where the optical fiber is fixed thereto, respectively. An optical fiber 10 includes: at least one core 11 made of quartz glass; a clad 12 that is provided around a periphery of the core 11 and has a refractive index lower than that of the core 11: and a resin coating layer 14 covering a periphery of the clad 12. The glass core 11 and the clad 12 form a glass fiber 13.

As illustrated in FIGS. 2A and 2B, for example, one end portions of four optical fibers 10 are fixed to a first fixing member 20. In the embodiment, as illustrated in FIG. 1B, the coating layer 14 at one end portion of the optical fiber 10 is stripped, the clad 12 of the glass fiber 13 is exposed, and the exposed glass fiber 13 is fixed to the first fixing member 20. The first fixing member 20 is a member for aligning the optical fibers 10, and is an approximately rectangular parallelepiped glass capillary member including pores 21. An inner diameter of the pore 21 is slightly larger than an outer diameter of the glass fiber 13, and when the glass fiber 13 is inserted into the pore 21, the glass fiber 13 is loosely fitted and positioned so as to be movable back and forth. The first fixing member 20 and the glass fiber 13 are fixed to each other by filling a gap between the pore 21 and the glass fiber 13 with an adhesive by using a capillary phenomenon.

FIGS. 2C and 2D are a front view and a side view illustrating another example of the first fixing member provided in the optical fiber connection component of the present disclosure to which the optical fiber is fixed in a state where the optical fiber is fixed thereto, respectively. A first fixing member 30 is formed of a V-groove circuit board 31 made of glass and a flat circuit board 32 also made of glass. The V-groove circuit board 31 includes, for example, four V-grooves 33 arranged in parallel, and each V-groove 33 has a size in which the glass fiber 13 can be placed. The flat circuit board 32 has a size that covers the respective V-grooves 33 of the V-groove circuit board 31 and has a flat shape. The glass fiber 13 is placed on each V-groove 33 of the V-groove circuit board 31, and is covered with the flat circuit board 32. The flat circuit board 32 is fixed to the V-groove circuit board 31 together with the glass fiber 13 with an adhesive. The first fixing member 30 including the V-groove circuit board 31 and the flat circuit board 32 has an approximately rectangular parallelepiped shape which is similar to that of the first fixing member 20.

The optical fiber 10 fixed to the first fixing members 20 and 30 may be one or a plurality of optical fibers other than four, and may be an optical fiber ribbon formed by taping a plurality of optical fibers 10 arranged in parallel with a common coating. The optical fiber 10 may include a single core or a plurality of cores. Tips of the first fixing members 20 and 30 to which the optical fiber 10 is fixed are polished together with the glass fiber 13, and are fixed to a circuit board on which an optical element is mounted, which is not illustrated, by, for example, an adhesive. Materials of the first fixing members 20 and 30 are desirably glass from a viewpoint of matching a coefficient of thermal expansion with the glass fiber 13, and may be resin.

When the optical fiber 10 is fixed to the first fixing members 20 and 30, the glass fiber 13 is exposed and fixed to the first fixing members 20 and 30, and may be fixed thereto in a state where the coating layer 14 is provided thereon. Therefore, in the present disclosure, the term “optical fiber” indicates an optical fiber in which the coating layer is provided on the glass fiber, and also includes an optical fiber in which the coating layer is partially stripped and the glass fiber is exposed. In the embodiment, the first fixing members 20 and 30 are provided on one end side of the optical fiber 10, and the above-described first fixing members 20 and 30 may be also mounted on the other end side of the optical fiber 10 and a tip thereof may be polished.

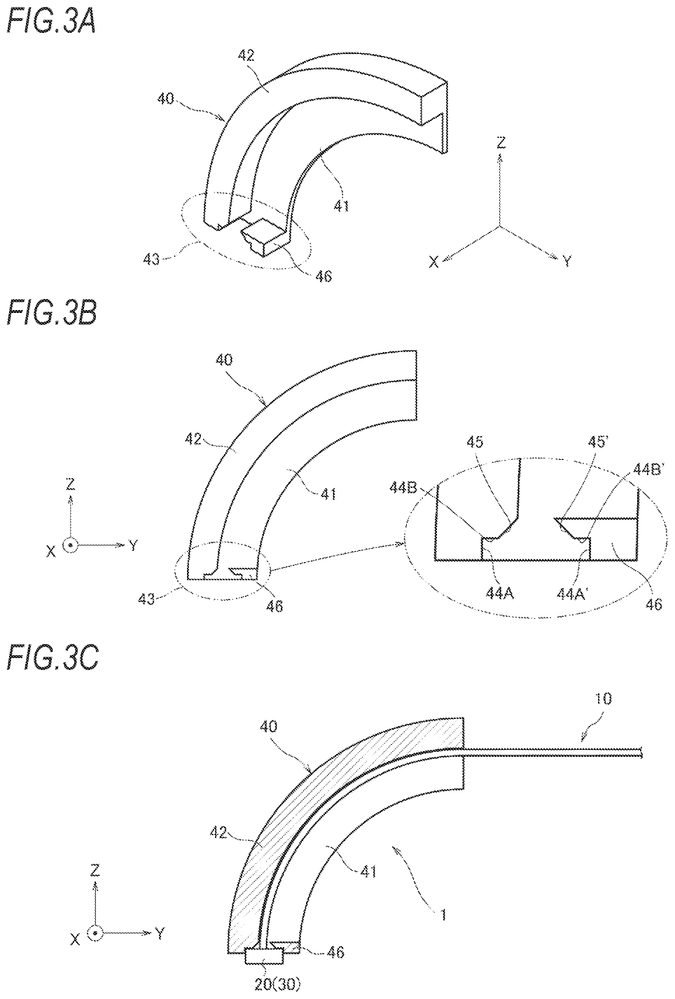

FIG. 3A is a perspective view illustrating an example 40 of the second fixing member provided in the optical fiber connection component of the present disclosure, and FIG. 3B is a side view of the second fixing member 40. FIG. 3C is a diagram illustrating an example in which the first fixing member is mounted on the second fixing member 40. The second fixing member 40 is a member for bending the optical fiber 10, the first fixing member 20 to which the optical fiber 10 is fixed (alternatively, the first fixing member 30 may be used. Hereinafter, the first fixing member 20 will be described as an example.) is positioned on one end side thereof, and the optical fiber 10 is bent along an inner peripheral surface of an outer peripheral wall 42 provided in the second fixing member 40.

As illustrated in FIG. 3A, the second fixing member 40 includes a side wall 41 having a circular arc shape on a YZ plane, and the outer peripheral wall 42 that has a circular arc shape and protrudes from the side wall 41 in a vertical direction (X-axis direction). A thickness of the outer peripheral wall 42 in the X-axis direction is such that the optical fiber 10 does not come off therefrom when the first fixing member 20, which will be described later, is mounted. A positioning portion 43 for positioning the first fixing member 20 is provided at one end of the second fixing member 40.

In the embodiment, the positioning portion 43 includes a positioning protrusion 46 protruding from one end portion of the side wall 41 of the second fixing member 40, and an end portion of the outer peripheral wall 42 facing the positioning protrusion 46. More specifically, the positioning portion 43 includes a positioning surface 44A parallel to an XZ plane at the end portion of the outer peripheral wall 42, a positioning surface 44B parallel to an XY plane, a positioning surface 44A′ parallel to the XZ plane of the positioning protrusion 46, a positioning surface 44B′ parallel to the XY plane, and the side wall 41. A distance between the positioning surface 44A of the outer peripheral wall 42 and the positioning surface 44A′ of the positioning protrusion 46 is equal to a width of two surfaces parallel to parallel surfaces of the optical fiber 10 of the first fixing member 20. Here, the positioning surfaces 44A and 44A′ parallel to the XZ plane are positioning surfaces parallel to the optical fiber 10, and the positioning surfaces 44B and 44B′ parallel to the XY plane are positioning surfaces perpendicular to the optical fiber 10.

The second fixing member 40 has an open surface on the side opposite to the side wall 41 with a wall surface of the outer peripheral wall 42 interposed therebetween. Therefore, when the first fixing member 20 to which the optical fiber 10 is fixed is positioned at the positioning portion 43 of the second fixing member 40, the first fixing member 20 is aligned so that the parallel surfaces of the optical fiber 10 fixed to the first fixing member 20 are parallel to the XZ plane, and the first fixing member 20 is inserted into the positioning portion 43 of the second fixing member 40 from an open surface side (positive side in the X-axis direction). Next, the first fixing member 20 is inserted until the first fixing member 20 abuts on the side wall 41.

As a result, the two surfaces parallel to the parallel surfaces of the optical fiber 10 of the rectangular parallelepiped first fixing member 20 are positioned by the positioning surface 44A of the outer peripheral wall 42 and the positioning surface 44A′ of the positioning protrusion 46. A surface into which the optical fiber 10 of the first fixing member 20 is inserted is positioned by the positioning surface 44B of the outer peripheral wall 42 and the positioning surface 44B′ of the positioning protrusion 46. One surface perpendicular to the parallel surfaces of the optical fiber 10 of the first fixing member 20 is positioned by the side wall 41. At that time, as illustrated in FIG. 3C, the optical fiber 10 is bent along the inner peripheral surface of the outer peripheral wall 42. In this state, the first fixing member 20, the positioning portion 43, and the optical fiber 10, and the inner peripheral surface of the outer peripheral wall 42 are fixed by using an adhesive which is not illustrated, thereby obtaining an optical fiber connection component 1. The adhesive can be supplied from the open surface side of the second fixing member 40.

A material of the second fixing member 40 may be any one of glass, metal, and resin as long as the outer peripheral wall 42 and the positioning portion 43 can be molded to be integrated with each other by cutting and molding. As illustrated in FIG. 3B, it is desirable that the positioning surface 44B of the outer peripheral wall 42 and the positioning surface 44B′ of the positioning protrusion 46 respectively include tapered surfaces 45 and 45′. As a result, when the first fixing member 20 is positioned at the second fixing member 40 and the optical fiber 10 is bent, it is possible to prevent the first fixing member 20 from deviating from the positioning portion 43, and to prevent the coating layer 14 of the optical fiber 10 and the glass fiber 13 inside the coating fiber 10 from being damaged by contacting the positioning portion 43. The tapered surfaces 45 and 45′ are respectively connected to the positioning surfaces 44B and 44B′ perpendicular to the optical fiber 10.

### Second Embodiment

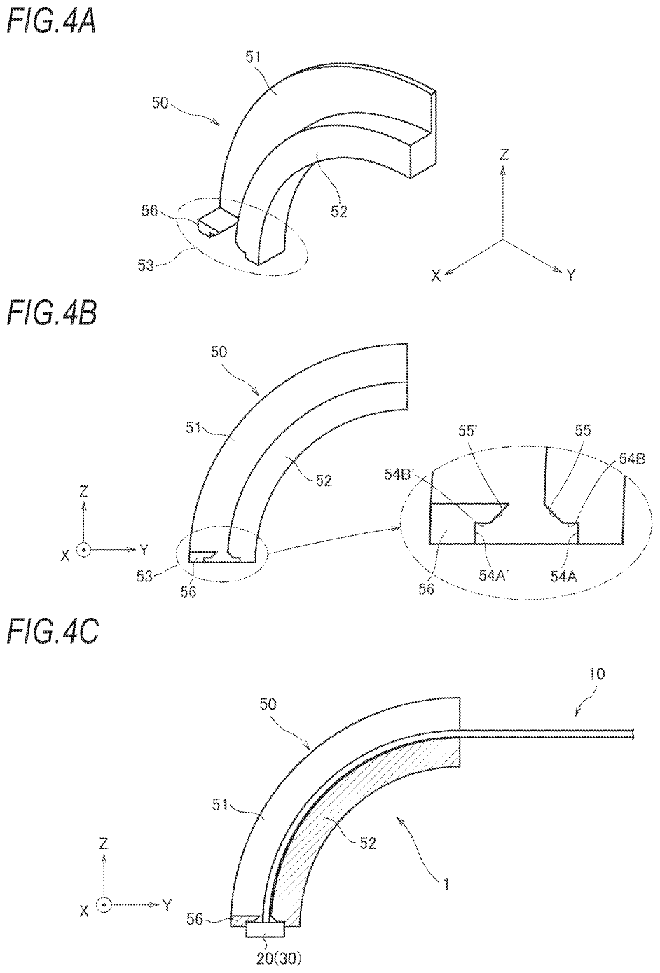

FIG. 4A is a perspective view illustrating another example 50 of the second fixing member provided in the optical fiber connection component of the present disclosure, and FIG. 4B is a side view of the second fixing member 50. FIG. 4C is a diagram illustrating an example in which the first fixing member is mounted on the second fixing member 50. The second fixing member 50 is a member for bending the optical fiber 10, the first fixing member 20 (or the first fixing member 30) to which the optical fiber 10 is fixed is positioned on one end side thereof, and the optical fiber 10 is bent along an outer peripheral surface of an inner peripheral wall 52 provided in the second fixing member 50.

As illustrated in FIG. 4A, the second fixing member 50 includes a side wall 51 having a circular arc shape on the YZ plane and the inner peripheral wall 52 that has a circular arc shape and protrudes from the side wall 51 in the vertical direction (X-axis direction). A thickness of the inner peripheral wall 52 in the X-axis direction is such that the optical fiber 10 can be placed when the first fixing member 20, which will be described later, is mounted. A positioning portion 53 for positioning the first fixing member 20 is provided at one end of the second fixing member 50.

In the embodiment, the positioning portion 53 includes a positioning protrusion 56 protruding from one end portion of the side wall 51 of the second fixing member 50, and an end portion of the inner peripheral wall 52 facing the positioning protrusion 56. More specifically, the positioning portion 53 includes a positioning surface 54A parallel to the XZ plane at the end portion of the inner peripheral wall 52, a positioning surface 54B parallel to the XY plane, a positioning surface 54A′ parallel to the XZ plane of the positioning protrusion 56, a positioning surface 54B′ parallel to the XY plane, and the side wall 51. A distance between the positioning surface 54A of the inner peripheral wall 52 and the positioning surface 54A′ of the positioning protrusion 56 is equal to a width of two surfaces parallel to the parallel surfaces of the optical fiber 10 of the first fixing member 20. Here, the positioning surfaces 54A and 54A′ parallel to the XZ plane are positioning surfaces parallel to the optical fiber 10, and the positioning surfaces 54B and 54B′ parallel to the XY plane are positioning surfaces perpendicular to the optical fiber 10.

The second fixing member 50 has an open surface on the side opposite to the side wall 51 with a wall surface of the inner peripheral wall 52 interposed therebetween. Therefore, when the first fixing member 20 to which the optical fiber 10 is fixed is positioned at the positioning portion 53 of the second fixing member 50, the first fixing member 20 is aligned so that the parallel surfaces of the optical fiber 10 fixed to the first fixing member 20 are parallel to the XZ plane, and the first fixing member 20 is inserted into the positioning portion 53 of the second fixing member 50 from an open surface side (positive side in the X-axis direction). Next, the first fixing member 20 is inserted until the first fixing member 20 abuts on the side wall 51.

As a result, the two surfaces parallel to the parallel surfaces of the optical fiber 10 of the rectangular parallelepiped first fixing member 20 are positioned by the positioning surface 54A of the inner peripheral wall 52 and the positioning surface 54A′ of the positioning protrusion 56. A surface into which the optical fiber 10 of the first fixing member 20 is inserted is positioned by the positioning surface 54B of the inner peripheral wall 52 and the positioning surface 54B′ of the positioning protrusion 56. One surface perpendicular to the parallel surfaces of the optical fiber 10 of the first fixing member 20 is positioned by the side wall 51. In the embodiment, in this state, first, the first fixing member 20 and the positioning portion 53 are fixed to each other with an adhesive. Next, as illustrated in FIG. 4C, the optical fiber 10 is bent along the outer peripheral surface of the inner peripheral wall 52. After that, the optical fiber 10 is fixed to the outer peripheral surface of the inner peripheral wall 52 with an adhesive, thereby obtaining the optical fiber connection component 1. The adhesive can be supplied by using the open surface of the second fixing member 50.

A material of the second fixing member 50 may be any one of glass, metal, and resin as long as the inner peripheral wall 52 and the positioning portion 53 can be molded to be integrated with each other by cutting and molding, in the same manner as that of the second fixing member 40 of the first embodiment. As illustrated in FIG. 4B, it is desirable that the positioning surface 54B of the inner peripheral wall 52 and the positioning surface 54B′ of the positioning protrusion 56 respectively include tapered surfaces 55 and 55′. As a result, when the first fixing member 20 is positioned at the second fixing member 50 and the optical fiber 10 is bent, it is possible to prevent the first fixing member 20 from deviating from the positioning portion 53, and to prevent the optical fiber 10 from being damaged by contacting the positioning portion 53. The tapered surfaces 55 and 55′ are respectively connected to the positioning surfaces 54B and 54B′ perpendicular to the optical fiber 10.

### Third Embodiment

In the embodiment, the second fixing member includes both the outer peripheral wall and the inner peripheral wall. Although an illustration is omitted, this embodiment has a structure including the outer peripheral wall 42 of the second fixing member 40 in the first embodiment and the inner peripheral wall 52 of the second fixing member 50 in the second embodiment. The positioning portion for positioning the first fixing member 20 is provided at the end portion of the outer peripheral wall and the inner peripheral wall. A gap is provided between the inner peripheral surface of the outer peripheral wall and the outer peripheral surface of the inner peripheral wall, and the optical fiber 10 is inserted into the gap. The gap may be designed to have approximately the same size as a diameter of the optical fiber 10, and the optical fiber 10 may be interposed between the outer peripheral wall and the inner peripheral wall in structure. The gap may be designed to be larger than the diameter of the optical fiber, and the optical fiber 10 may be fixed in the gap between the outer peripheral wall and the inner peripheral wall by filling an adhesive from the open surface.

As described above, in each embodiment, the positioning portion is formed to be integrated with the end portion of the outer peripheral wall or the inner peripheral wall, and may be provided separately from the outer peripheral wall or the inner peripheral wall.

### REFERENCE SIGNS LIST

1: optical fiber connection component
10: optical fiber
11: core
12: clad
13: glass fiber
14: coating layer
20, 30: first fixing member
21: pore
31: V-groove circuit board
32: flat circuit board
33: V-groove
40: second fixing member
41: side wall
42: outer peripheral wall
43: positioning portion
44A, 44A′, 44B, 44B′: positioning surface
45, 45′: tapered surface
46: positioning protrusion
50: second fixing member
51: side wall
52: inner peripheral wall
53: positioning portion
54A, 54A′, 54B, 54B′: positioning surface
55, 55′: tapered surface
56: positioning protrusion

1. An optical fiber connection component, comprising:
an optical fiber;
a first fixing member to which one end portion of the optical fiber is fixed; and
a second fixing member that includes either one or both of an outer peripheral wall and an inner peripheral wall having a curvature along which the optical fiber is aligned and being adhered to the optical fiber with the adhesive and a positioning portion for positioning the first fixing member at one end of the second fixing member.

2. The optical fiber connection component according to claim 1,
wherein the second fixing member includes: a side wall from which either one or both of the outer peripheral wall and the inner peripheral wall vertically protrudes; and having an open surface on a side opposite to the side wall with a wall surface of either one or both of the outer peripheral wall and the inner peripheral wall interposed therebetween.

3. The optical fiber connection component according to claim 1,
wherein the positioning portion at the one end portion includes:
a positioning surface parallel to the optical fiber;
a positioning surface perpendicular thereto; and
a tapered surface connected to the positioning surface perpendicular thereto.

4. The optical fiber connection component according to claim 1,
wherein the first fixing member includes a hole through which the optical fiber penetrates.

5. The optical fiber connection component according to claim 1,
wherein the first fixing member includes two plate-shaped members that sandwich the one end portion of the optical fiber.
